(19) United States
(12) Patent Application Publication
(10) Pub. No.: US 2012/0296722 A1
(43) Pub. Date: Nov. 22, 2012

(54) METHODS AND SYSTEM TO PERFORM WIRELESS FINANCIAL TRANSACTIONS

(75) Inventors: Charudatta M. Gosavi, Kothrud (IN); Ravi Ajitbhai Bhojani, Rajkot (IN); Yogesh Prakash Thakur, Panvel (IN); Rakesh Kumar, Pune (IN); Prashant Kumar Sinha, Aundh (IN)

(73) Assignee: Infosys Limited, Bangalore (IN)

(21) Appl. No.: 13/242,264

(22) Filed: Sep. 23, 2011

(30) Foreign Application Priority Data
May 18, 2011 (IN) 1689/CHE/2011

(51) Int. Cl. G06Q 30/02

(52) U.S. Cl. 705/14.23

(57) ABSTRACT

A method, system and computer program product for performing a financial transaction at a transaction host are disclosed. The method includes the step of receiving, at the transaction host, a first set of information from an electronic portable device. The method further includes the step of identifying an associated account of a user using an identifier from the first set of information, determining loyalty points accrued in the identified associated account; a value proportional to the loyalty points is then subtracted from a first transaction amount to give a second transaction amount. The financial transaction worth the second transaction amount is completed using the payment instrument details derived from the first set of information. The method also includes automatically creating an account for the user using the identifier when the user doesn't have any past transaction associated with the transaction host.

The present invention relates, generally, to the field of mobile banking and more specifically, to a method and system to perform wireless financial transactions.

### BACKGROUND OF THE INVENTION

Not long before, when a person wanted to purchase commodities, he/she had to physically hand cash/coins or give a hand-written check to the vendor/merchant. The subsequent arrival of cards containing a magnetic strip, which have to be “swiped” through a payment terminal made purchasing of commodities relatively easy than handling currency notes and coins.

There are various categories of cards that may be used to purchase commodities. One such category of cards includes payment cards such as credit cards, debit cards, gift cards, and cards for various prepaid services or goods. Another category includes those that contain information related to loyalty reward programs, such as those operated by airlines, grocery stores, and other retail merchants. Yet another category can be referred to as “smart cards”. Electronic coupons, tokens, tickets, personal identification information, and other information can also be stored on these cards. However, using these cards is cumbersome since the specific card to be used must be removed from a physical wallet, which may contain beside cash, multiple cards.

Existing digital mobile wallets have converted such physical cards into digital cards. However, again, the user has to select more than one card; e.g., at a point of sale (POS) terminal, typically, the following steps have to be performed: the user has to login to the mobile wallet using his/her user credentials; the user has to select the debit/credit/prepaid card and pass it to the reader at the POS to make the payment; wait and then select the loyalty card and pass it to the POS to reap the benefits and rewards of being a loyal customer. A gift coupon, which is in the form of a card, may also need to be selected and passed to the POS to redeem the value stored in it.

As may be apparent, this is a time consuming process and can be frustrating for the user. Accordingly, there is a need for a system and a method that do not require the user to select more than one type of card for a single transaction. Further, the system and method should reduce the waiting time of the user.

### SUMMARY OF THE INVENTION

An embodiment of the invention provides for a system for performing financial transactions at a transaction host. The system includes an electronic portable device with a memory that stores and executes an application, a transceiver that communicates a first set of information to a transaction host. Further, the system includes a processor at the transaction host that extracts an identifier to identify an associated account of the user, determines the loyalty points accrued, also processes a set of predefined rules to calculate a value proportional to the loyalty points, and subtracts the value from a first transaction amount to give a second transaction amount. The financial transaction worth the second transaction amount is completed using payment instrument details obtained through the first set of information. The system also includes an account generation module which automatically creates an account in case a user doesn't have a past transaction associated with the transaction host.

An alternative embodiment is a method for performing a financial transaction at a transaction host. The method includes the step of receiving, at the transaction host, a first set of information from an electronic portable device. The method further includes the step of identifying an associated account of a user using an identifier from the first set of information. Furthermore, the method includes determining loyalty points accrued in the identified associated account; a value proportional to the loyalty points is then subtracted from a first transaction amount to give a second transaction amount. The financial transaction worth the second transaction amount is completed using the payment instrument details derived from the first set of information. The method also includes automatically creating an account for the user using the identifier when the user doesn't have any past transaction associated with the transaction host.

These and other features and advantages will be more clearly understood from the following detailed description taken in conjunction with the accompanying drawings and claims.

### DETAILED DESCRIPTION

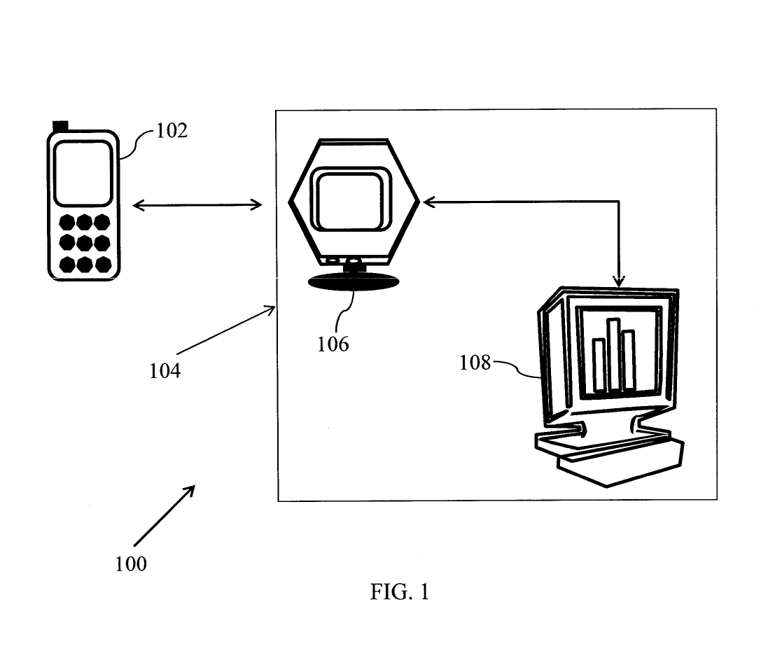

FIG. 1 illustrates a financial transaction system 100 in which the present invention can be practiced;

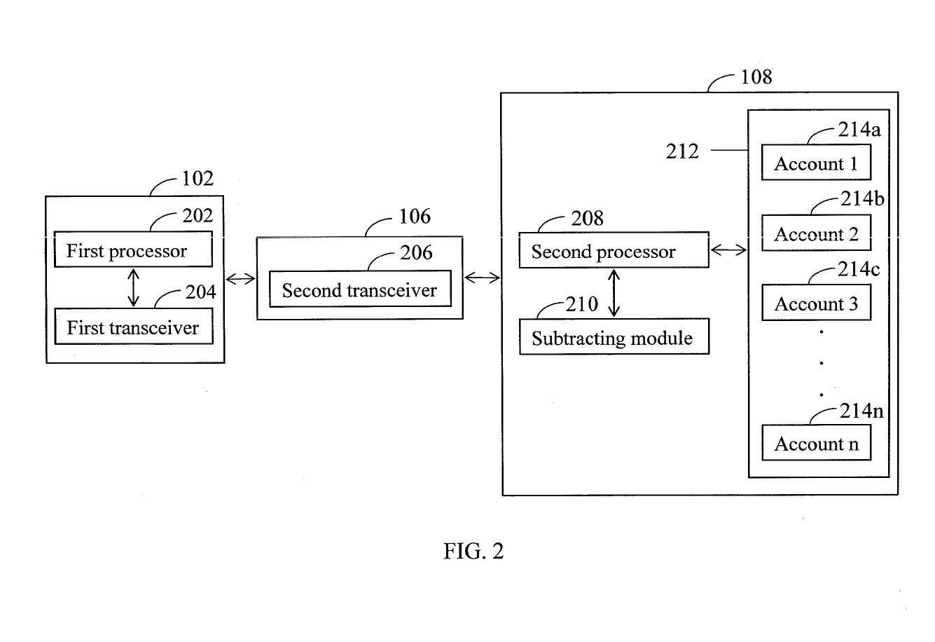

FIG. 2 illustrates a schematic block diagram of system 100, in accordance with an embodiment of the present invention;

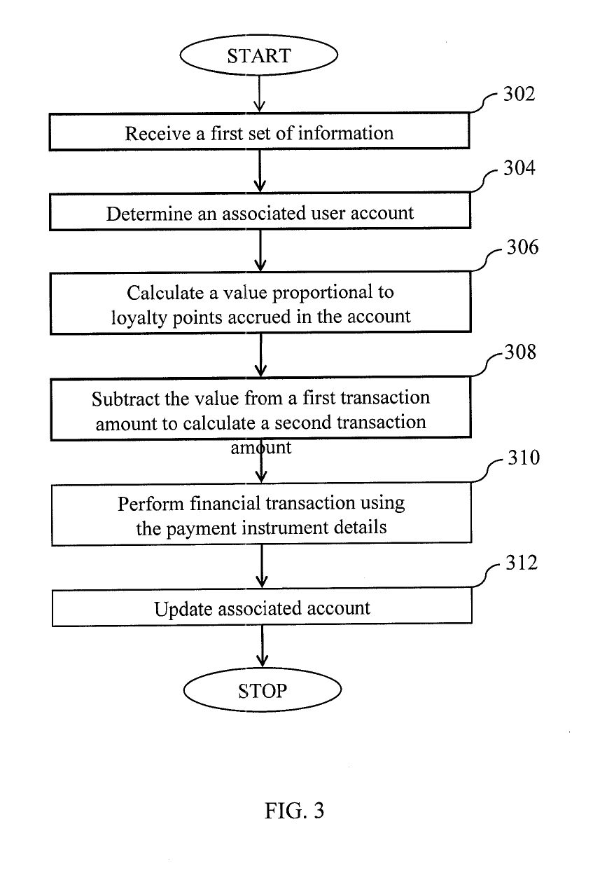

FIG. 3 is a flow chart illustrating a method of performing a financial transaction at a transaction host, in accordance with an embodiment of the present invention;

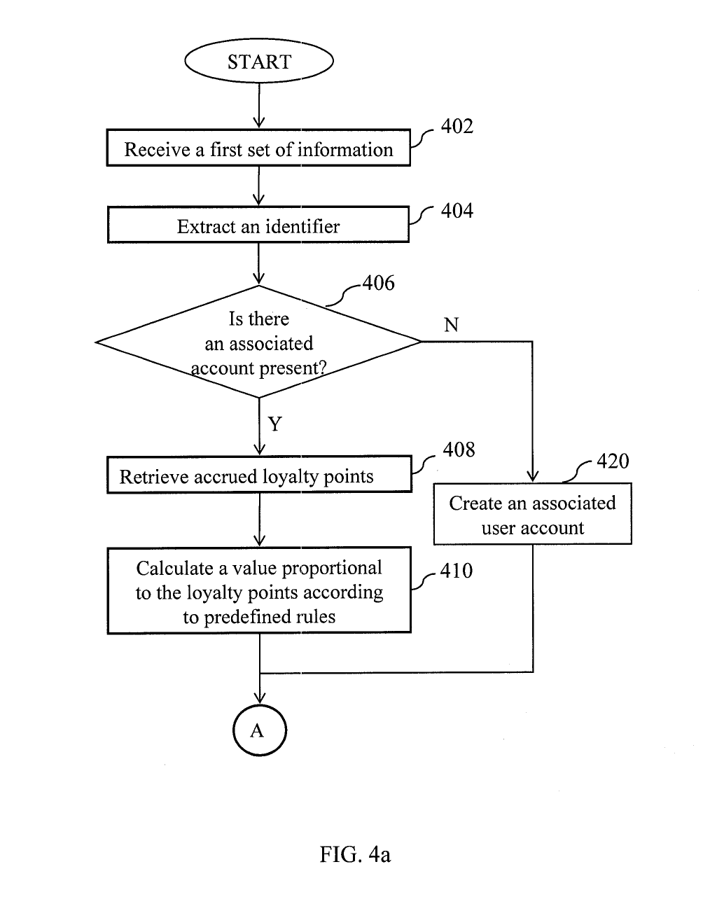

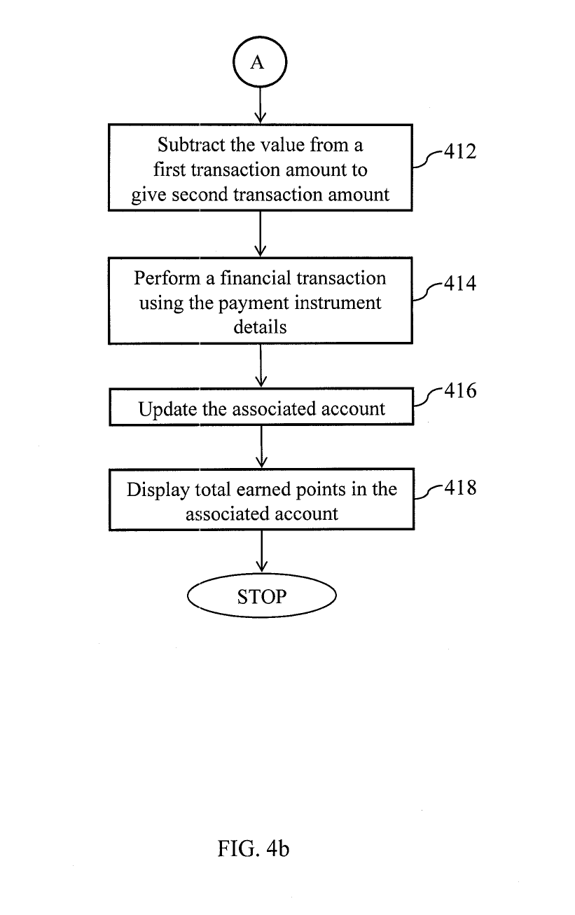

FIGS. 4a and 4b represent a flow chart illustrating a method of performing a financial transaction at the transaction host, in accordance with another embodiment of the present invention; and

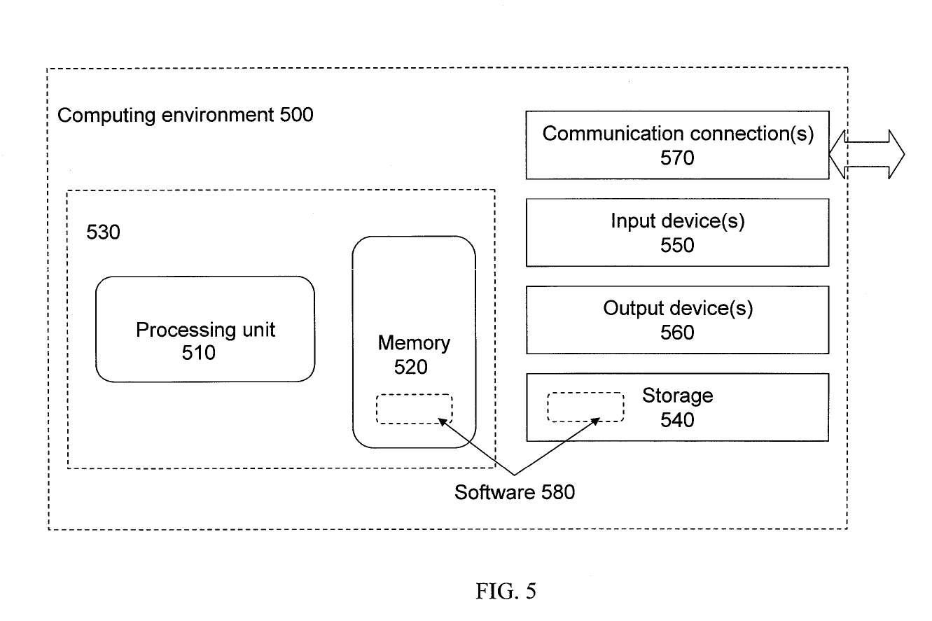

FIG. 5 is an Exemplary Computing Environment.

The following description is the complete informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

The present invention relates to a method for performing a financial transaction at a transaction host for purchase of commodities by a user. According to the method described in the present invention, a first set of information is received at the transaction host from the user's electronic portable device, extracts a unique identifier of the user and payment instrument details from the received first set of information. User's associated account stored at the transaction host is identified using the identifier. A value proportional to loyal points accrued in the user's associated account is computed according to a set of predefined rules; the value is then subtracted from a first transaction amount to give a second transaction amount. Payment instrument details are then utilized to complete the financial transaction.

Further, the associated account of the user is updated with earned points accrued as a result of the financial transaction. An amount equivalent to total earned points in the associated account is displayed on the user's electronic portable device.

In addition, a user account is automatically created for the identifier if no associated account is present for the user.

Additionally, the present invention relates to a system for performing a financial transaction at a transaction host for purchase of commodities by a user. The system includes an electronic portable device and a transaction host. The electronic portable device, in turn, includes a first processor and a first transceiver. The first processor stores and executes an application whereas the first transceiver communicates a first set of information to a reader at the transaction host. The first set of information is further sent to a second processor present in a computer system at the transaction host. The second processor extracts an identifier to identify an associated account of the user and determines the loyalty points accrued. The second processor further processes a set of predefined rules to calculate a value proportional to the loyalty points and subtracts the value from a first transaction amount to give a second transaction amount. Subsequently, the financial transaction worth the second transaction amount is completed using payment instrument details.

Further, the system includes a module for updating the associated account of the user with earned points accrued as a result of the financial transaction. An amount equivalent to total earned points in the associated account is displayed on the electronic portable device of the user.

In addition, the system also includes an account generation module that automatically creates an account if a user does not have any past transaction associated with the transaction host.

FIG. 1 illustrates a financial transaction system 100 in which the present invention can be practiced. System 100 includes an electronic portable device 102 and a transaction host 104. Transaction host 104 further includes a reader 106 and a computer system 108.

In accordance with various embodiments of the present invention, electronic portable device 102 displays a mobile wallet login screen to a user (not shown in the figure). The user inputs his/her credentials to access the mobile wallet and selects a first set of information to be transmitted to transaction host 104 to perform a financial transaction. Reader 106 at transaction host 104 receives the first set of information transmitted by the electronic portable device 102 and passes the first set of information to computer system 108 for processing. Computer system 108 extracts an identifier and payment instrument details from the first set of information. An associated account of the user is identified using the extracted identifier, loyalty points accrued in the associated account is retrieved, and a value proportional to the loyalty points is calculated using a predefined set of rules. The calculated value is then subtracted from a first transaction amount to result in a second transaction amount, which is the final amount payable by the user. The payment instrument details are used to complete the financial transaction.

Further computer system 108 updates the associated account of the user with earned points accrued as a result of the financial transaction. An amount equivalent to total earned points in the associated account is displayed on electronic portable device 102.

In accordance with an embodiment of the present invention, computer system 108 automatically creates a user account for the identifier if no associated account is present for the user. The user account may contain various details of the user such as loyalty card number, name, address, phone numbers, driving license number, accrued loyalty points, associated coupons, and so forth.

FIG. 2 illustrates a schematic block diagram of system 100, in accordance with an embodiment of the present invention. System 100 includes an electronic portable device 102, a reader 106 and a computer system 108. Electronic portable device 102 includes a first processor 202 and a first transceiver 204. Reader 106 comprises includes a second transceiver 206. Computer system 108 includes a second processor 208, a subtracting module 210, a database 212 and multiple accounts 214a, 214b, 214c and so on till 214n.

As explained earlier in conjunction with FIG. 1, portable electronic device 102 includes a mobile wallet application. First processor 202 executes the mobile wallet application and displays a login screen to a user (not shown in the figure), on electronic portable device 102. The user inputs his/her credentials and selects a first set of information on electronic portable device 102. First transceiver 204 transmits the first set of information to second transceiver 206, which is then passed to second processor 208. Second processor 208 extracts an identifier from the first set of information. Further, second processor 208 determines an associated account of the user using the extracted identifier. In other words second processor 208 checks whether the user has any past transaction associated with computer system 108. In case the user has an associated account, second processor 208 retrieves loyalty points accrued in the associated account and calculates a value proportional to the loyalty points using a set of predefined rules. Subtracting module 210 subtracts the value computed from a first transaction amount to give a second transaction amount and sends the second transaction amount back to second processor 208. On receiving the second transaction amount, second processor 208 completes a financial transaction equivalent to the second transaction amount using the payment instrument details.

Subsequently, the associated account of the user is updated with earned points accrued as a result of the financial transaction at computer system 108. Second transceiver 206 transmits information regarding an amount equivalent to the total earned points in the associated account to the first transceiver 204. First transceiver 204 sends this information to first processor 202, which displays the information on portable electronic device 102 of the user.

In accordance with various embodiments of the present invention, the first set of information includes an identifier and payment instrument details. The payment instrument may be any of a credit card, a debit card, a purchase card, a gift card or an account holding value. Further, the identifier may be a combination of digits, alpha-numeric characters, and symbols. For example, the identifier may be a user's phone number, loyalty card number, user's driving license number, user's voting card number, and the like. In one of the embodiments, the user may select the concerned loyalty card along with the payment card from the list of soft cards displayed to the user on the electronic portable device.

The predefined set of rules may include a default multiplication factor, loyalty parameters, and purchase history of the user.

FIG. 3 is a flow chart illustrating a method of performing a financial transaction at a transaction host, in accordance with an embodiment of the present invention. At step 302, a first set of information is received at a transaction host, such as transaction host 104, from the electronic portable device, such as electronic portable device 102, of a user. In accordance with various embodiments of the present invention, the first set of information includes an identifier and payment instrument details. The payment instrument may be any of a credit card, a debit card, a purchase card, a gift card or an account holding value. Further, the identifier may be a combination of digits, alpha-numeric characters, and symbols. For example, the identifier may be a user's phone number, loyalty card number, user's driving license number, user's voting card number, and the like. In one of the embodiments, the user may select the concerned loyalty card along with the payment card from the list of soft cards displayed to the user on the electronic portable device.

At step 304, an associated account of the user at the transaction host is identified using the identifier extracted from the received first set of information. At step 306, a value proportional to loyalty points accrued in the associated account is computed using a set of predefined rules. In accordance with an embodiment of the present invention, the predefined set of rules includes a default multiplication factor, loyalty parameters, and purchase history of the user. At step 308, the computed value is subtracted from a first transaction amount to give a second transaction amount. The first transaction amount is equivalent to a total amount billed for commodities purchased by the user at the transaction host. At step 310, the financial transaction for the second transaction amount is completed using the payment instrument details. Finally, at step 312, the associated account of the user at the transaction host is updated with earned points accrued as a result of the financial transaction.

The first set of information may be transmitted from the electronic portable device to the transaction host via any of near field communication (NFC), Bluetooth, a text message, radio frequency identification (RFID), and the like. It will be apparent to a person skilled in the art that the first set of information may include other details in addition to the payment instrument details and the identifier, such as, for example, a PIN, a phone number.

FIGS. 4a and 4b represent a flow chart illustrating a method of performing a financial transaction at a transaction host, in accordance with another embodiment of the present invention. At step 402, a first set of information is received at the transaction host, such as transaction host 104, from the electronic portable device, such as electronic portable device 102, of a user. At step 404, an identifier is extracted from the received first set of information. In accordance with various embodiments of the present invention, the first set of information includes an identifier and payment instrument details. The payment instrument may be any of a credit card, a debit card, a purchase card, a gift card or an account holding value. Further, the identifier may be a combination of digits, alpha-numeric characters, and symbols. For example, the identifier may be a user's phone number, loyalty card number, user's driving license number, user's voting card number, and the like. In one of the embodiments, the user may select the concerned loyalty card along with the payment card from the list of soft cards displayed to the user on the electronic portable device.

At step 406, it is checked whether an associated account of the user is present at the transaction host. If the associated account of the user exists at the transaction host, then accrued loyalty points are retrieved from the identified associated account of the user at step 408. At step 410, a value proportional to the retrieved loyalty points is computed using a set of predefined rules. In accordance with an embodiment of the present invention, the predefined set of rules includes a default multiplication factor, loyalty parameters, and purchase history of the user. At step 412, the computed value is subtracted from a first transaction amount to give a second transaction amount. At step 414, the financial transaction equivalent to the second transaction amount is completed using the payment instrument details. At step 416, the associated account of the user at the transaction host is updated with earned points accrued as a result of the financial transaction. Finally, at step 418, about an amount equivalent to total earned points in the associated account is displayed to the user on the portable electronic device.

However, if at step 406, it is determined that no associated account of the user is present at the transaction host, an associated account for the user is created automatically using the identifier extracted from the first set of information, at step 420. After the associated account is created, the control flows to step 412, where the computed value is subtracted from a first transaction amount to give a second transaction amount. Subsequent steps, namely steps 414 through 418 are then performed, as described earlier.

One or more of the above-described techniques can be implemented in or involve one or more computer systems. FIG. 5 illustrates a generalized example of a computing environment 500. The computing environment 500 is not intended to suggest any limitation as to scope of use or functionality of described embodiments.

With reference to FIG. 5, the computing environment 500 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 580 implementing described techniques.

A computing environment may have additional features. For example, the computing environment 500 includes storage 540, one or more input devices 550, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which can be used to store information and which can be accessed within the computing environment 500. In some embodiments, the storage 540 stores instructions for the software 580.

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

The communication connection(s) 570 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 500, computer-readable media include memory 520, storage 540, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

We claim:

1. A method for performing a financial transaction at a transaction host using a portable electronic device, the method comprising:
receiving, at the transaction host, a first set of information from the portable electronic device, wherein the first set of information comprises an identifier associated with a user of the wireless handheld device and payment instrument details;
identifying an associated account of the user, stored in the transaction host, using the identifier, when the user has a past transaction with the transaction host;
determining loyalty points accrued by the user in the associated account;
subtracting an amount proportional to the loyalty points accrued by the user from a first transaction amount to calculate a second transaction amount, wherein the amount proportional to the loyalty points is calculated using a predefined set of rules; and
performing a financial transaction worth the second transaction amount using the payment instrument details.

2. The method according to claim 1, further comprises updating, in the transaction host, the associated account of the user with earned points accrued as a result of the financial transaction.

3. The method according to claim 2, further comprises displaying on the portable electronic device, an amount equivalent to total earned points in the associated account.

4. The method according to claim 1, further comprises creating, automatically, a user account for the identifier in the transaction host, when the user has no past transaction with the transaction host.

5. The method according to claim 1, wherein receiving the first set of information at the transaction host from the wireless handheld device happens via a near field communication (NFC) link, Bluetooth, text message, and radio frequency identification (RFID).

6. The method according to claim 1, wherein the payment instrument is one of a credit card, debit card, purchase card, gift card, and an account holding value.

7. The method according to claim 1, wherein the portable electronic device is one of a cellular phone, PDA (personal digital assistant), music player, MC70, and any wireless handheld device.

8. The method according to claim 1, wherein the transaction host is a point of sale (POS) terminal, server, and electronic device.

9. The method according to claim 8, wherein the transaction host has branches at different locations.

10. The method according to claim 1, wherein the identifier is a combination of digits, alpha-numeric series, and symbols.

11. The method according to claim 1, wherein the identifier may be a user's phone number, loyalty card number, user's driving license number, and user's voting card number.

12. The method according to claim 1, wherein the associated account belongs to the user of the organization managing the transaction host.

13. The method according to claim 1, wherein the loyalty points are accrued in the associated account as a consequence of past transactions or purchase of commodities done by the user at the transaction host.

14. The method according to claim 1, wherein the loyalty points are one of coupons, and tokens.

15. The method according to claim 1, wherein the first transaction amount is equivalent to a total amount billed for commodities purchased at the transaction host.

16. The method according to claim 1, wherein the predefined set of rules comprises a default multiplication factor, loyalty parameters, and purchase history of the user.

17. A system for performing a financial transaction at a transaction host using a portable electronic device, the system comprising:
at the portable electronic device:
a memory enabled to store an application, wherein the application is executed by a first processor; and
a transceiver configured to communicate with the transaction host via a communication technique;
at the transaction host:
a receiving module to receive a first set of information transmitted by the portable electronic device;
a second processor configured to:
extract an identifier from the first set of information, wherein the identifier is used to identify an associated account of the user;
determine loyalty points accrued in the identified associated account;
subtract an amount proportional to the loyalty points from a first transaction amount to calculate a second transaction amount; and
perform a financial transaction worth the second transaction amount using payment instrument details, wherein the payment instrument details is a part of the first set of information.

18. The system according to claim 16, wherein the second processor identifies the associated account when the user has a past transaction.

19. The system according to claim 16, further comprising account generation module to automatically create a user account for the identifier in the transaction host, when the user has no past transaction with the transaction host.

20. The system according to claim 16, wherein the second processor calculates the amount proportional to the loyalty points using a predefined set of rules.

21. The system according to claim 16, further comprises a module to update, in the transaction host, the associated account of the user with earned points accrued as a result of the financial transaction.

22. The system according to claim 16, wherein the first processor displays at the portable electronic device an amount equivalent to total earned points in the associated account.

23. The system according to claim 16, wherein the loyalty points are accrued in the associated account as a consequence of past transactions or purchase of commodities done by the user at the transaction host.

24. The system according to claim 16, wherein the loyalty points is one of coupons, and tokens.

25. The system according to claim 16, wherein the communication technique is one of near field communication (NFC) link, Bluetooth, radio frequency identification (RFID), and text message.

26. The system according to claim 16, wherein the payment instrument is one of a credit card, debit card, a purchase card, gift card, and an account holding value.

27. The system according to claim 16, wherein the portable electronic device is one of a cellular phone, PDA (personal digital assistant), music player, MC70, and any wireless handheld device.

28. The system according to claim 16, wherein the transaction host is one of a point of sale (POS) terminal, a server at a retail store, and an electronic device.

29. The system according to claim 27, wherein the transaction host has branches at different locations.

30. The system according to claim 16, wherein the identifier is a combination of digits, alpha-numeric series, and symbols.

31. The system according to claim 16, wherein the identifier may be a user's phone number, loyalty card number, user's driving license number, and user's voting card number.

32. The system according to claim 16, wherein the associated account belongs to the user of the organization managing the transaction host.

33. The system according to claim 16, wherein the first transaction amount is equivalent to a total amount billed for commodities purchased at the transaction host.

34. The system according to claim 16, wherein the predefined set of rules comprises a default multiplication factor, loyalty parameters, and purchase history of the user.

35. A computer program product for performing a financial transaction at a transaction host using a portable electronic device, the computer program product comprising:
instructions to receive, at the transaction host, a first set of information from the portable electronic device, wherein the first set of information comprises an identifier associated with a user of the wireless handheld device and payment instrument details;
instructions to identify an associated account of the user, stored in the transaction host, using the identifier, when the user has a past transaction history with the transaction host;
instructions to determine loyalty points accrued by the user in the associated account;
instructions to subtract an amount proportional to the loyalty points accrued by the user from a first transaction amount to calculate a second transaction amount, wherein the amount proportional to the loyalty points is calculated using a predefined set of rules; and
instructions to perform a financial transaction worth the second transaction amount using the payment instrument details.

36. The computer program product as recited in claim 33, further comprising program instructions to update, in the transaction host, the associated account of the user with earned points accrued as a result of the financial transaction.

37. The computer program product as recited in claim 33, further comprising program instructions to display on the wireless handheld device, an amount equivalent to total earned points in the associated account.

38. The computer program product as recited in claim 33, further comprising program instructions to create, automatically, a user account for the identifier in the transaction host, when the user has no past transaction history with the transaction host.

39. The computer program product according to claim 33, wherein the payment instrument is one of a credit card, debit card, a purchase card, gift card, and an account holding value.

40. The computer program product according to claim 33, wherein the portable electronic device is one of a cellular phone, PDA (personal digital assistant), music player, MC70, and any wireless handheld device.

41. The computer program product according to claim 33, wherein the transaction host is a point of sale (POS) terminal, server, an electronic device.

42. The computer program product according to claim 39, wherein the transaction host has branches at different locations.

43. The computer program product according to claim 33, wherein the identifier is a combination of digits, alpha-numeric series, and symbols.

44. The computer program product according to claim 33, wherein the identifier may be a user's phone number, loyalty card number, user's driving license number, and user's voting card number.

45. The computer program product according to claim 33, wherein the associated account belongs to the user of the organization managing the transaction host.

46. The computer program product according to claim 33, wherein the loyalty points are accrued in the associated account as a consequence of past transactions or purchase of commodities done by the user at the transaction host.

47. The computer program product according to claim 33, wherein receiving the first set of information at the transaction host from the wireless handheld device happens via a near field communication (NFC) link, Bluetooth, text message, and radio frequency identification (RFID).

48. The computer program product according to claim 33, wherein the loyalty points are one of coupons, and tokens.

49. The computer program product according to claim 33, wherein the first transaction amount is equivalent to a total amount billed for commodities purchased at the transaction host.

50. The computer program product according to claim 33, wherein the predefined set of rules comprises a default multiplication factor, loyalty parameters, and purchase history of the customer.
